(19) United States
(12) Patent Application Publication
(10) Pub. No.: US 2007/0021131 A1
(43) Pub. Date: Jan. 25, 2007

(54) Method for delayed entering into a conversation or renewed entering into a conversation of at least one radio communication device in an already existing push-to-talk group discussion, radio communication device, exchange unit and radio communication network

(76) Inventors: Josef Laumen, Munich (DE); Andreas Schmidt, Braunschweig (DE); Norbert Schwagmann, Braunschweig (DE); Markus Trauberg, Velchede (DE)

Correspondence Address: BELL, BOYD & LLOYD, LLC, P. O. BOX 1135, CHICAGO, IL, 60690-1135, US

(21) Appl. No.: 10/555,718

(22) PCT Filed: Feb. 16, 2005
(86) PCT No.: PCT/EP05/50666

§ 371 Date: Nov. 7, 2005

(30) Foreign Application Priority Data
Mar. 3, 2004 (DE) 10 2004 010368.2

(51) Int. Cl. H04B 7/00

(52) U.S. Cl. 455/518; 455/90.2

(57) ABSTRACT

For delayed entering into a conversation or renewed entering into at least one radio communication device is an already existing push-to-talk group discussion of several radio communication devices, whereby the already delivered conversation totals have already been stored in at least one intermediately switched exchange unit, one or several conversation totals are transmitted from the exchange unit to the delayed radio communication device for the PTT group discussion and played back.

### BACKGROUND

In radio communication networks, especially mobile radio networks, what are known as Push-To-Talk (PTT) services are of interest. In these services direct voice communication is implemented between two or more radio communication devices or mobile stations of a specific push-to-talk group discussion, which is characterized in particular in that, at any point in time, only one operator of one of the radio communication devices involved can speak selectively, i.e. alone, whereas for this period while they are speaking speech entry and especially speech transmission is disabled or blocked for the users of the other radio communication devices involved in the push-to-talk group discussion. While one of the users is speaking in the relevant push-to-talk group discussion, the other users involved can only listen, i.e. they can only receive the conversation total of the sending radio communication device in each case and not simultaneously transmit messages themselves. So that the user concerned can activate a conversation transmission, a specific extra PTT key or an activatable menu item on the operating surface the Human-Machine Interface (HMI) is expediently provided on their terminal, especially mobile radio terminal. To enable a conversation total or information total to be sent to the other members of the PTT group, the user concerned presses this PTT key or activates this menu item. This enables the speech information to be transmitted from their terminal to a exchange unit in the radio network assigned on the network side, which forwards this to all other radio communication devices involved as receivers of the PTT group. The exchange unit is in this case formed by what is known as a PTT server. While the user of the sending radio communication device keeps their PTT key pressed or keeps the corresponding menu item activated, they alone are allocated the authorization to transmit by the PTT server, whereas the transfer of voice messages by other users is blocked in the PTT server. In this way, the Push-To-Talk service provides a half-duplex technology in which the speech information of a PTT application or of a radio communication device is initially transmitted to an assigned PTT exchange unit in the radio network and from there to the PTT applications on the other mobile stations or radio communication devices involved in the PTT group session. In this case, only one of the mobile stations involved in a group discussion can ever send at a particular time, with all other mobile stations only being able to receive.

This type of push-to-talk group discussion can present difficulties for the involvement of a user that is a late entrant to the discussion between other PTT users once it is already underway.

Accordingly, a delayed entry or renewed entry system and method is disclosed.

The delayed or renewed entering into a conversation occurs via at least one radio communication device into a push-to-talk group discussion of a number of radio communication devices which is already taking place, for which the issued conversation totals have been stored beforehand in at least one intermediate exchange unit. Under an exemplary embodiment, one or more missed conversation totals are transmitted by the exchange unit to the radio communication device which is the late entrant into the push-to-talk group discussion and are reproduced on this device.

With this method, even with a delayed entry or the entry of a user into a push-to-talk group discussion which has already been started and is underway, a largely complete provision of information is ensured for this new user. This is because the method makes it possible for him to find out about conversation totals already stored by the users previously involved. If the new entrant so desires, he can listen within a finite listening time to the content of one or more old stored conversation totals either entirely or in part or he can skip one or more of these conversation totals either entirely or in part. He can thus bring himself up-to-date with the current status of information of the push-to-talk group discussion which is underway and then, by utilizing the information content of the stored conversation totals, can participate actively and passively in the current discussion. In this way the exchange of voice messages in a push-to-talk group discussion can already begin before all the participants in the discussion are ready to receive. Those users who have booked into a specific group session earlier than users who are entering it at a later time can already start the group discussion even if not all users have booked into the relevant session or discussion yet. This largely avoids unwanted waiting times. Some of the participants in the group discussion can continue this discussion while one or more of the previous participants leave the PTT discussion for a period and re-register with it at a later time. The fact that the conversation totals of the radio communication devices involved earlier or continuing later in the relevant ongoing PTT group discussion are stored on an assigned exchange unit, and one or more of these stored conversation totals is transmitted to the radio communication device entering later, i.e. newly entering or re-entering after a specific interruption is transmitted by the exchange unit and notified to it means that it is not necessary for this user who enters later to actively direct requests to each of the participants involved earlier or who are continuing in the discussion as to which conversation totals or information for the group discussion currently underway have been exchanged by them before they booked in or during their absence. Users who enter into the PTT group discussion later and thus miss the beginning of the PTT group discussion, or who have interrupted this discussion and are now re-registering in the PTT discussion, can thus obtain retrospective information automatically about the already communicated conversation totals of the participants involved earlier or about the new conversation totals which were issued during the interruption period or timeout by the remaining participants to the continuing push-to-talk discussion. The user entering the discussion after a delay in each case can synchronize with the information status of the users already involved earlier and thus participate on an equal footing in the group discussion currently being held.

The present disclosure also relates to a radio communication device having a control unit for executing the exemplary method.

The present disclosure further relates to an exchange unit with a control device and a memory device for executing the exemplary method disclosed herein.

The present disclosure also relates to a radio communication network with at least one exchange unit, with the aid of which, for a push-to-talk group discussion of a number of radio communication devices, the exemplary method is executed.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 is a schematic diagram of a radio network architecture for executing a push-to-talk group discussion of a number of radio communication devices into which a new user with their radio communication device enters after a delay or re-enters after a pause and wherein information regarding conversation totals already issued are provided;

FIG. 2 is a schematic diagram of display, input and control means of a radio communication device that enters the push-to-talk group of radio communication devices after a delay, as shown in FIG. 1; and

FIG. 3 is a schematic diagram of a signalling sequence of radio signals between the radio communication device of FIG. 1 which is participating after a delay in a specific push-to-talk group discussion, and an exchange unit of the radio communication subsystem in accordance with FIG. 1 which stores the already transmitted conversation totals of the radio communication devices of FIG. 1 already involved earlier in the PTT group discussion.

### DETAILED DESCRIPTION

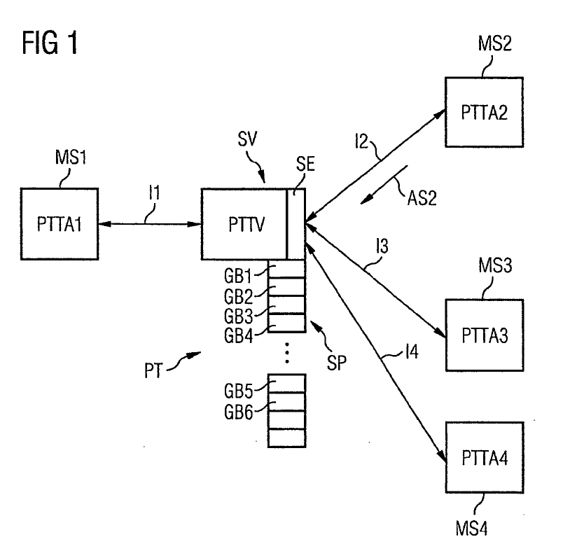

Components with same function and method of operation are shown in FIGS. 1 through 3 with the same reference symbols in each case.

FIG. 1 shows a schematic diagram of the network architecture of a part system or subsystem of a radio communication network. This subsystem has, as its network component, an exchange unit SV which provides a specific push-to-talk (PTT) service for a group of several radio communication devices. The exchange unit SV is especially embodied as what is known as a PTT server. Here in the exemplary embodiment of FIG. 1 three radio communication devices MS2, MS3, MS4 form a PTT group for example which begin a specific push-to-talk group discussion PT with the aid of the exchange unit SV. In this case each radio communication device MS2 to MS4 is connected via an associated separate communication connection or an associated separate message path 12, 13, 14 selectively to the exchange unit SV. Each transmission path 12, 13, 14 also includes at least one air interface, i.e. a radio connection over the air between the relevant radio communication devices and the base station in its relevant location area cell. To make the drawing in FIG. 1 easier to understand these base stations as well as their assigned cellular radio cells are not shown in the Figure. The exchange unit SV is preferably connected to a higher-ranking radio network control unit, such as to an RNC, i.e. “Radio Network Controller” for example or to a GPRS (General Packet Radio Service) network node and is thus a component of the radio network infrastructure. Mobile stations, especially cellular telephones, are preferably used as radio communication devices. The PTT service is preferably implemented in a GPRS or UMTS (Universal Mobile Telecommunication System) radio communication system.

During the push-to-talk group discussion of this already existing group of three radio communication devices MS2, MS3, MS4, only the user of one of the radio communication devices involved in the discussion may transmit at the same time a conversation total or a communication message to the radio communication devices of the other subscribers of the PTT group discussion with intermediate switching by the exchange unit. While a specific radio communication device of the group is sending, the transfer of voice messages is blocked for all other radio communication devices of this group by the exchange unit, so that their operators only hear the conversation total sent in each case, i.e. can only receive, and cannot themselves send a voice message during this transmission time.

In the exemplary embodiment shown in FIG. 1, the user of the radio communication device MS2 opens the PTT group discussion PT by pressing a special PTT key on their radio communication device MS2 or activating a corresponding menu item on its user interface. By doing this they generate a control signal AS2, with which they request from the exchange unit SV a transmit or send authorization for their first conversation total GB1 in order to have this transmitted by the exchange unit SV to the other two radio communication devices MS3, MS4 involved. The exchange unit SV then checks whether the user of the requesting radio communication device MS1, as the first of all the users of the PTT group formed by the radio communication devices MS2 to MS4, has requested the send authorization from the exchange unit SV. If the user of the radio communication device MS2 has the most advanced time ranking, the exchange unit SV assigns the radio communication device MS2 the desired exclusive send authorization for a specifiable maximum authorization period, within which the transfer of the conversation total GB1 is allowed. The user of the radio communication device MS2 then issues their conversation total GB2 over the communication connection 12 to the exchange unit SV. This features a control unit SE for management or administration of incoming and outgoing conversation totals. With the aid of this unit the first conversation total GB1 is stored in a memory device SP. With the aid of its control unit SE, the exchange unit SV forwards the conversation total GB1 via the communication connections I3, I4 to the radio communication devices MS3, MS4 such that their users can hear the conversation total GB1 almost in realtime. After the user of the radio communication device MS2 has released their PTT key after their conversation total GB1 has been issued, the transfer authorization is withdrawn again from the radio communication device MS2 by the control unit SE of the exchange unit SV.

The user of the radio communication device MS3 then requests from the exchange unit SV, in a corresponding manner, a transfer authorization for issuing a separate conversation total GB2 to the other two radio communication devices MS2, MS4 involved. The user does this by pressing the PTT key on radio communication device MS3, which generates and sends a request signal. The desired transmit authorization is granted to them by the control unit SE of the exchange unit SV since a new transfer authorization was to be issued and no other radio communication device MS2, MS4 has been given a PTT transmit authorization by the exchange unit SV. The exchange unit SV therefore assigns the radio communication device MS3 the highest transmission priority. While the user of the radio communication device MS3 holds their PTT key down they can issue their conversation total GB2 via the communication connection I3 to the exchange unit SV. Its control unit SE stores the second conversation total GB2 in the memory device SP in this case.

The user of the radio communication device MS2 replies to the second conversation total GB2 with a further conversation total GB3 in that, in a similar way to the first time for the first conversation total GB1, they request from the exchange unit SV a transmit authorization by pressing their PTT key. The allocation of the desired transmit authorization to the radio communication device MS2 and the forwarding of the third conversation total GB3 to the other radio communication devices MS3, MS4 involved is executed in a similar manner to the conversation total GB1 by the exchange unit SV. This third conversation total GB3 is also stored by the control unit SE of the exchange unit SV in the memory device SP. After transfer of the third conversation total GB3, the transmit authorization is withdrawn again by the exchange unit from the radio communication device MS2.

Finally the user of the radio communication device MS4 contributes a separate conversation total GB4 to the ongoing PTT group discussion. To do this, in the same way as the users of the radio communication device MS2, MS3, they press a special PTT key on their radio communication device MS4. In doing so they request the exchange unit SV to issue the transmit authorization for transfer of a conversation total GB4 to the other two radio communication devices MS2, MS3. This transmit authorization is issued to them by the control unit SE of the exchange unit SV if the users of the other radio communication devices involved, MS2, MS3 have not previously requested a higher-priority transmit authorization and been granted it. This is not the case here in the exemplary embodiment, so that the control unit SE issues the transmit authorization to the radio communication device MS4. Subsequently the conversation total GB4 is sent by the radio communication device MS4 to the exchange unit SV and stored there in the memory SP. Simultaneously the fourth conversation total GB4 is forwarded via the communication connections I2, I3 to the two radio communication devices MS2, MS3 which are currently involved as further members in the PTT group discussions.

Under the exemplary embodiment, all the conversation totals, i.e. the totals GB1 to GB4 in this case, which have already been issued chronologically, i.e. one after the other, by the users of the radio communication devices MS2, MS3, MS4 involved in the ongoing PTT group discussion, are stored in the memory device SP.

If a new user now additionally registers their radio communication device later, i.e. delayed in relation to the issue times of one or more conversation totals of the existing PTT group of radio communication devices for this PTT group, this can make the participation of the user entering late into the conversation sequence of the previous PTT users difficult. The same applies when a user leaves the ongoing PTT discussion or interrupts it for a specific period of time and then re-registers again after this absence.

To make its possible for the user who enters into an ongoing push-to-talk group discussion PT later or re-enters it after leaving to have a simple method of delayed entry or of re-entry into a conversation in this group discussion PT while being simultaneously provided with largely complete information about the conversation totals already transmitted earlier or transmitted in their absence, the exchange unit advantageously transmits one or more missed conversation totals to the radio communication device entering the push-to-talk group discussion late and these are reproduced on this device. Preferably it is made possible for the delayed or returning user hear these missed conversation totals more quickly via his radio communication device.

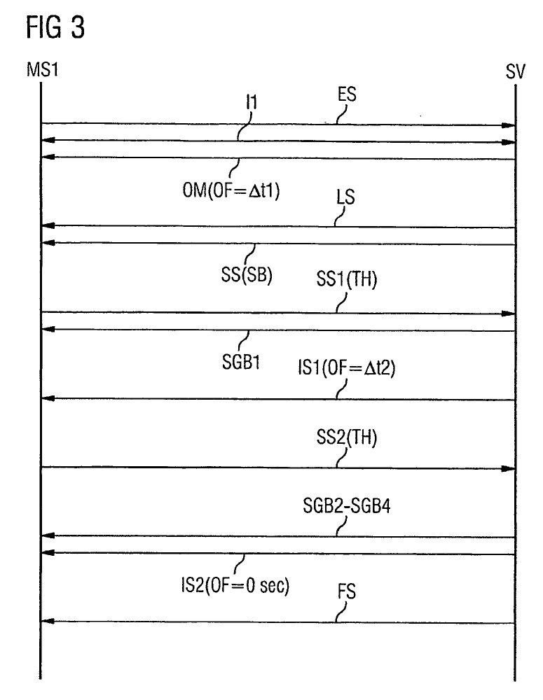

In FIG. 1 the radio communication device MS1 is registered by its user at the exchange unit SV as a new member of the existing PTT group of the previously involved radio communication devices MS2, MS3, MS4. Accordingly, the radio communication device MS1 is in contact via a communication connection I1 with the exchange unit SV, so that control signals and/or conversation totals can be exchanged between the control unit SE of the exchange unit SV and the radio communication device MS1 in both directions. The new radio communication device MS1 entering the group registers with the aid of a control signal (see FIG. 3) with the exchange unit SV as a new member of the existing PTT group PT and the previous members MS2, MS3, MS4 administered under this PTT group PT. This signaling sent out over the air interface of the radio communication device MS1 to the exchange unit SV is shown schematically in FIG. 3. Subsequently, the communication protocol I1 is opened between the new radio communication device MS1 and the exchange unit SV. Since the control unit SE of the exchange unit SV establishes that when the registration signal ES arrives, conversation totals GB1 to GB4 of the radio communication devices MS2, MS3, MS4 previously involved in the PTT group discussion are already present in the memory device SP, it registers the addition or the arrival of the radio communication device MS1 for the existing PTT group as late or delayed. With the aid of an information signal OM the exchange unit SV notifies the newly registered radio communication device MS that it is being held decoupled from the current PTT group discussion PT, i.e. in “offline” mode, by the control unit SE until the already stored conversation totals GB1 to GB4 have been partly or entirely played and/or actively, i.e. deliberately, partly or entirely skipped. In this “offline mode” of the newly registered radio communication device MS1 this device can preferably not yet participate as from the time of its registration in the ongoing PTT group discussion PT of the previous radio communication devices MS2, MS3, MS4. Instead of immediately allowing the conversation totals of the user of the newly entered radio communication device MS1 for the continuing PTT group discussion PT the radio communication device MS1 is preferably decoupled from, i.e. kept out of the continuing PTT group discussion PT by the control unit SE of the exchange unit SV until its user has actively taken the opportunity to play either a part or all of the stored conversation totals GB1 with GB4 and/or to skip a part or all of them. In other words, the newly entering radio communication device MS1 is not allowed by the control unit SE of exchange unit SV into the current push-to-talk group discussion PT of the existing radio communication devices MS2, MS3, MS4 until the exchange unit SV has entirely or partly transmitted one or more missed conversation totals GB1 to GB4 to the radio communication device MS1 entering late into the PTT group discussion PT and these have been listened to or these missed conversation totals GB1 to GB4 have been entirely or partly skipped in the memory device SP. Only when the user of the delayed entry radio communication device MS1 has acquainted themselves with the current status of the push-to-talk group discussion PT by listening to the missed conversation totals GB1 to GB4 and/or by skipping the missed conversation totals GB1 to GB4 are they allowed by the control unit SE of the exchange unit SV to participate in the current push-to-talk group discussion.

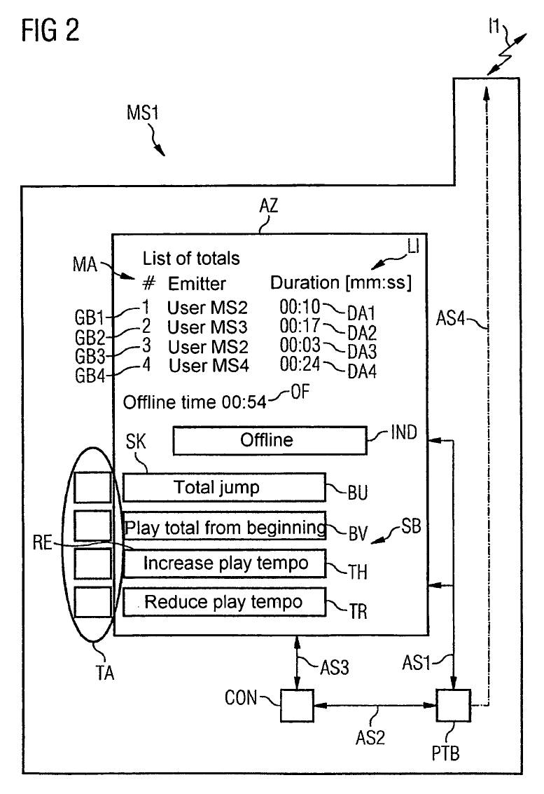

Status information is signalled with the aid of the control signal OM of the exchange unit SV to the late entry radio communication device MS1, indicating how much time (OF=Δtl) is likely to be needed for reproduction of the stored conversation totals GB1 to GB4 until the current state of the push-to-talk group discussion PT is reached. The fact that the radio communication device MS1 is initially in “offline” mode after its registration with PPT group PT is indicated to the operator of radio communication device MS1 on their display AZ in a separate indicator field IND. This is shown schematically in FIG. 2. In this diagram the indicator field IND is used to visualize the “offline” operating state to the user of the radio communication device MS1 in the display device AZ. In addition, the exchange unit SV uses a control signal LS (see FIG. 3) to send the late entrant into the discussion group, the radio communication device MS1, a list LI of the conversation totals GB1 to GB4 sent by the radio communication devices MS2 to MS4 already participating in the PTT group discussion PT. This list LI with the already issued conversation totals GB1 with GB4 of the users of the radio communication devices MS2 to MS4 previously involved is also shown to the operator of the newly entered radio communication device MS1 in the display panel of the display device AZ. Specifically, each conversation total GB1 to GB4 is assigned both its sending radio communication device MS2 to MS4 and also its call duration time DA1 to DA4. Furthermore, the sum of the conversation time durations is shown in a further part of the display of the display device AZ as “offline” time OF. This is the total time which has elapsed when playing all already stored conversation totals GB1 to GB4, i.e. for normal listening to the conversation totals GB1 to GB4.

The calculation can also, where necessary, include the time which will elapse for the additional conversation totals such as for example GB5, GB6 which will arrive while the stored conversation totals are being played. This time can be estimated since what is seen from a particular standpoint as the future communication behavior of the participants in the discussion is not known. To update the display of the remaining “offline” time OF on the radio communication device MS1 the exchange unit SV, preferably at intervals, sends an updated value of the probable remaining “offline” line OF for display on the radio communication device MS1. In particular, after each arrival of a new conversation total such as GB5, GB6 in the memory device SP of the control unit SE, the overall playing time is updated and then signalled to the newly participating radio communication device MS1.

The operator of the newly entered radio communication device MS1 can register in an existing PTT group PT by pressing the PTT key PTB on their radio communication device MS1. Holding down this PTB key generates a control signal AS4 which sends the control signal ES for booking the device into the existing PTT group over the air interface I1 to the exchange unit SV. Naturally the desired PTT group as well as the associated registration process can also be selected in each case with the aid of a menu of a normal HMI (Human Machine Interface).

So that the operator of the radio communication device MS1 entering the discussion group late has the opportunity to listen more quickly to the conversation totals GB1 to GB4 of the existing radio communication devices MS2 to MS4 stored in the memory device SP of the exchange unit SV the late entry radio communication device MS1 is sent by the exchange unit SV with the aid of a control signal SS a selection list SB for selection of one or more control commands. These are used for influencing or for manipulation, i.e. control of the reproduction of the stored conversation totals GB1 to GB4. A selection list with control commands is thus loaded from the late entry radio communication device by the control unit of the exchange unit and sent to the delayed radio communication device. This loading process can be omitted if on the delayed radio communication device there is already a selection list with a command set stored in advance, with the aid of which the reproduction of the conversation totals stored in the memory device can be controlled during downloading

FIG. 2 shows an exemplary display on the display device AZ for four typical control commands SK, AS, TH, TR for influencing the reproduction of the previously issued conversation totals GB1 to GB4 of the three previously participating radio communication devices MS2 to MS4. Individually these are the following control commands:

SK=“Total jump”,

RE=“Play total from beginning”,

TH=“Increase play tempo”, and

TR=“Reduce play tempo”.

These control commands can be accessed selectively e.g. with the aid of the specific PTT key PTB or by tapping on a particular menu item when using a touch screen as display device AZ on the newly entered radio communication device MS1. To this end, when the PTT key PTB is pressed accordingly, a control signal AS2 is sent to a control unit CON which creates a selection signal AS3 for selection of an optional control command.

In the present exemplary embodiment, the operator of the newly entered radio communication device MS1 enters the command RE “Play total from the beginning” for the first stored conversation total GB1. Simultaneously they select the control command TH “Increase play tempo”. The choice of this selection or the exercising of this option of a specific control command, namely RE and TH in this case, for reproducing the conversation total GB1 is transmitted by the radio communication device MS1 with the aid of a control signal SS1 over its air interface to the exchange unit SV. Its control unit SE then loads the first stored conversation total GB1 from its memory device SP, executes the selected and transmitted control command on it, and transmits the conversation total manipulated in this way from the beginning with the desired increased playback speed over the communication connection I1 by means of an information signal SGB1 to the radio communication device MS1. In this case, the user of the radio communication device MS1 may increase or to reduce the tempo at which it is played by using the control commands TH or TR even during the reproduction of the first conversation total GB1, which triggers a corresponding reaction in the exchange unit SV on the conversation total retrieved from its memory device SP.

Alternately, separately provided keys TA may specifically select the control commands for reproduction of the stored conversation totals which are assigned to the menu items of the control commands SK, RE, TH, TR in the display of the display device AZ at the side of the display or in some other unique way. Also, a touch screen can be provided as a display device, which allows the operator to tap a menu item with their finger to select and generate the corresponding control commands and send them to the exchange unit SV.

After the reproduction of the first conversation total GB1 for late entry user of the radio communication device MS1 the sum of the remaining speaking time is displayed for the conversation totals GB2 to GB4 which have not yet been listened to in subfield OF. To this end an information signal IS1 is transmitted by the exchange unit SV with the remaining offset time OF=Δt2 to the radio communication device MS1. In this way that period of time which would be required for completely playing the rest of the remaining conversation totals GB1 to GB4 is continuously updated. In a similar way the remaining playing time is displayed to the user of the radio communication device MS1 in the subfield OF if the user is merely listening to a part of the conversation total GB1 already stored.

The operator of the radio communication device MS1 would eventually also like to listen to the stored conversation totals GB2 to GB4 at a higher tempo. He signals this requirement to the control unit SE of the exchange unit SV with the aid of a control signal SS2 which contains the control command TH. The exchange unit SV then uses information signals SGB2 to SGB4 to transmit the required conversation totals GB2 to GB4 to the radio communication device MS1 as desired with a playing speed increased in relation to the original recording, i.e. a higher tempo. After all conversation totals GB1 to GB4 have been completely transmitted to the late entry radio communication device MS1 and reproduced there, the exchange unit SV signals with the aid of an information signal IS2 that the offline time OF 0 is now 0 seconds. In this case the radio communication device MS1 changes to “online mode”, i.e. into a state in which it is now authorized to actively participate in the current PTT session of the radio communication devices MS2, MS3, MS4 already involved. The late entry radio communication device MS1 is allowed to participate in the current PTT group discussion by the exchange unit SV through a control signal FS so that it can send its own conversation totals.

So that the user of the late entry radio communication device MS1 can obtain as quickly as possible the current information status of the operators of the previously participating radio communication devices MS2 to MS4, it is especially expedient for the conversation totals already stored in the exchange unit SV, such as GB1, to be played at a higher tempo of for their reproduction by the control unit SE of the exchange unit SV. The user of the radio communication device MS1 can have this done with the aid of the corresponding control command, such as TH for example, sent to the exchange unit SV.

In addition to or independently of this, it can be expedient for the late entry radio communication device such as MS1 for pauses to be left between the individual already stored conversation totals, such as GB1 to GB4, which have been shortened or omitted when reproduced.

In addition to or independently of this it may also be expedient for the late entry radio communication device to also shorten or omit pauses within the relevant stored conversation total itself, such as GB1, when reproduced.

As an alternative to faster reproduction it can be expedient to skip the relevant stored conversation total such as GB1 entirely or partly. The user of the radio communication device MS1 can signal this with the aid of a corresponding control command SK to the exchange unit SV.

The communication connections I1 to 14 (see FIG. 1) between each of the radio communication devices MS1 to MS4 participating in the PTT session and the exchange unit SV for the desired PTT session are established, especially with the UMTS (Universal Mobile Telecommunication system) via the “Radio Access Network (RAN)”, the Core Network (CN) and the IP Multimedia system (IMS). Instead of this network architecture for executing a PTT session other networks or network components such as a PSTN (Public Switched Telephone Network) can be used.

So that one or more missed conversation totals are transmitted to the radio communication device entering the push-to-talk group discussion late and reproduced more quickly there by the exchange unit, the late entry user may be brought up to date with the current status of the calling PTT discussion and then to participate on an equal basis in relation to the users already participating in the discussion. Unnecessary inquiries to each individual user previously involved as to which information they have already exchanged with each other at the beginning of the PTT discussion can thus advantageously be omitted. This means that tedious interruptions to the continuing PTT group discussion are largely avoided. Instead, the late entry user can be automatically informed about the conversation totals of the previous users already issued. In this way, the exchange of voice messages for a PTT group discussion may begin even before all discussion participants are booked in for the PTT group discussion and their radio communication devices are ready to receive. An ongoing PTT discussion can also be continued by the remaining users if a previous user leaves the group for a break or a timeout. Despite the late entry or renewed entry into a conversation after a timeout of the relevant subscriber in the PTT group discussion already in progress, a complete provision of information for this new or re-registered user is guaranteed. Since the conversation totals previously delivered in the push-to-talk group discussion already begun are stored in the intermediate exchange unit for the PTT group discussion, from the memory unit of which they are retrieved by the relevant late entry radio communication device by at least one transmitted control command, reproduced more quickly there by means of a control unit and are able to be transmitted to the requesting radio communication device such that the late entry user can participate after a finite time in the PTT discussion with the current information status of the ongoing PTT group discussion actively and passively. Before the late entry user can participate in the current PTT discussion actively and passively in online mode, the conversation totals of the previous users already exchanged and stored on the PTT exchange unit are transmitted on request by the corresponding transfer of control commands on the part of the late entry radio communication device to the latter and reproduced there via its user interface. Until the conversation totals stored in the PTT exchange unit have been processed by the late entry subscriber, their radio communication device is preferably kept in the “offline mode”. in this “offline mode” the late entry user or user re-entering the discussion after an interruption cannot yet actively participate in the current PTT group discussion. More specifically, the late entry user, with the aid of corresponding control commands to the control unit of the exchange unit, may have the conversation totals of the group discussion in progress already stored there played back at a higher speed and to transfer these conversation totals running faster than the originals to the radio communication device. The reproduction of the stored original conversation totals can especially be changed by control commands which increase the playback speed
of the totals (moderately) and/or
leave out or shorten pauses between the different conversation totals of the discussion, and/or
leave out pauses within the conversation totals of the discussion.

The PTT service of the intermediate PTT exchange unit advantageously signals to the individual user of the PTT discussion on their radio communication device whether they are already up to date with the current status of the PTT discussion or are still to be played stored information (especially at higher speed) by the exchange unit. The indication can for example be provided optically, by means of LEDs or through a specific symbol in the display for example, or acoustically. The distinction between whether a user is already participating in the PTT discussion in realtime or is still being played the stored conversation totals can especially also be used to decide whether the user may on request send their own conversation total for PTT discussion or not, i.e. whether they are also given the right to read by the PTT exchange unit or not. A further useful functionality is the provision of information by the PTT exchange unit as to how long it is likely to take until the relevant late entry user will reach the current status of the discussion, from which time they can actively participate in the PTT discussion in realtime. This can be indicated in hours, minutes and seconds, that is by specifying a length of time which is generated by the PTT exchange unit, transmitted to the PTT application on the receiving radio communication device of the late entry user and shown there. It is especially useful to implement on the relevant late entry radio communication device a control for playing back the conversation totals stored on the exchange unit. The control advantageously enables the playback speed of the conversation totals stored on the PTT exchange unit to be reduced or extended. Furthermore it can be useful to transmit a list of the conversation totals still stored on the PTT exchange unit to the PTT application on the relevant late entry radio communication device. This list can be arranged in chronological order for example, and preferably contains the following information:
Date and time of day
Duration
Sender
etc.

On the basis of this list the late entry user can advantageously decide whether they would like to skip individual totals or a number or totals, or whether they would like to hear some or all of them again. The options for action in this case are offered to the relevant late entry user of the PTT application on their radio communication device. This is supported by a corresponding PTT application on the PTT exchange unit. If the user activates an action option, this information is transmitted accordingly to the PTT exchange unit by means of one or more control signals to which the PTT exchange unit reacts in the desired manner. The particularly provides the following advantages:
A user can enter into a discussion after a delay, can leave a discussion temporarily, enter it again and still listen to the totals that they have missed or have them output.
The increased playback speed rapidly brings the late entry user concerned up to date with the current status of the PTT discussion and allows them to make their own qualified contributions earlier.
A display of the conversation totals still outstanding along with their relevant durations and the accumulated, predicted total conversation duration allows the relevant late entry user to better estimate what totals they can expect all in all and how long it will take until they are up to date with the current status of the ongoing PTT group discussion.

With additional control options such as reducing the playback tempo, increasing the playback tempo, skipping a total/totals for example, the relevant late entry user can select the totals that are of relevance or importance to them and reduce the time until they are up to date with the current status of the ongoing PTT group discussion.

The calculation of the overall time remaining until the current status of the PTT discussion is reached is based in this case on the durations of the individual conversation totals which are still to be played back before the current status of the PTT discussion is reached. Furthermore the calculation can particularly take account of the following,
that the totals may be played back more quickly,
that the pauses in the conversation totals will be reduced or omitted,
that individual conversation totals may be skipped and/or
that during the playback of the currently available totals new totals may possibly be added which will also need to be taken into account, e.g., by playing them back or skipping them.

Communication between the PTT-application such as PTTA1 on the relevant late entry radio communication device such as MS1 and the PTT application such as PTTV in the PTT exchange unit such as SV for executing the PTT group discussion is advantageously expanded by one or more of the following functionalities:
Signaling the “offline mode” by the PTT exchange unit to the PTT application of the relevant late entry radio communication device,
Signaling the list of conversation totals still to be transmitted in “offline mode” with detailed information in accordance with the above list including marking of the current total being reproduced by the PTT exchange unit on the PTT application of the late entry radio communication device,
Signaling the probable remaining time until the current status of the PTT discussion is reached (“offline time”) by the PTT exchange unit to the PTT application of the relevant late entry radio communication device,
Signaling the possible control commands for influencing the reproduction by the PTT application from the PTT exchange unit to the PTT application of the relevant late entry radio communication device, and/or
Signaling a control command selected by the relevant late entry user for example on their radio communication device from the PTT application there to the PTT application on the PTT exchange unit and corresponding execution of the relevant control command selected by the PTT application on the PTT exchange unit.

In a PTT system including a PTT exchange unit and a number of PTT applications on a number of radio communication devices which are involved in a PTT group session such that a number of PTT applications with different time delays are entering the PTT group session, the PTT exchange unit can advantageously control the transmission and output of the stored discussion totals. The playback speed of the totals is preferably set for each PTT application individually and, depending on the individual delay in relation to the ongoing PTT session, all of the PTT applications connected with a delay into the group discussion may reach the current status of the PTT discussion at the same point in time.

In an alternative embodiment, the transmission and output of the discussion totals for the delayed entry PTT applications can also only be controlled by the PTT exchange unit itself. The control option on the radio communication device side can then be removed. The relevant PTT application on the radio communication device involved can thus remain unaffected by the control, which can be advantageous on grounds of compatibility with the PTT applications already used on radio communication devices. The PTT exchange unit in this case merely plays back the stored conversation totals until the current status of the discussion is reached. The PTT session for the relevant PTT application then goes into the normal status in which the totals sent to the PTT exchange unit are distributed directly to the PTT user application on the relevant radio communication devices. One difference in the presentation, in relation to the user, is the type of scenario in which the PTT exchange unit is necessary also at the request of the user/the PTT application does not assign any right to send to this user/application if the PTT application has not yet reached the current status of the discussion. It is advantageous in this case that the user can not deliver totals which are not based on knowledge of the current discussion status. For this variant no requirements for the PTT application in accordance with the prior art are needed.

The fact that the exchange unit transfers one or more missed conversation totals to the radio communication device which is a late entrant to the PTT group discussion and that these will especially be reproduced at a higher speed there enables users which book into to an agreed PTT group session early to start the discussion even if not all users are booked into the session/discussion. The users booking in with a delay subsequently can still be sure that they will be able to retrieve from the PTT exchange unit all information of conversation totals already issued. Accordingly, a user previously involved can also leave the PTT group for a specific time or take a timeout and have the missed conversation totals of the remaining users played back to them when they book back in again. The functional expansions disclosed here of the PTT service and the corresponding implementations by functional expansions of the PTT exchange unit, the PTT application on the relevant radio communication device involved, the user interface between the relevant radio communication device and the communication between the PTT exchange unit and the PTT application on relevant radio communication device involved are useful here.

The PTT architecture in the exemplary embodiment of FIG. 1 features a PTT exchange unit SV with a PTT control application PTTV as well as a number of PTT applications PTTA1, PTTA2. PTTA3, PTTA4 on radio communication devices MS1, MS2, MS3, MS4 which are connected via the associated mobile radio transmission links I1, I2, I3, I4 to the PTT exchange unit SV. In this context FIG. 2 shows an example of a user interface of the late entry radio communication device MS1 with the PTT application PTTA1 and the elements display device AZ and input keyboard TA. The display device AZ comprises a list LI with the conversation totals GB1 to GB4 still to be transmitted/played back. The individual conversation totals GB1 to GB4 are in this case shown individually by a number, the name/the address of the sender, the duration of the conversation time and possibly further information which is not shown in FIG. 2. Examples of such information are: a subject of the total, a summary of the total (language, audio, video, text, etc.). In the list of the totals the current total being reproduced is specifically identified. In FIG. 2 a triangular marking is used for this purpose for example. Furthermore the following information is visualized in the display device AZ under the exemplary embodiment:
the predicted time until the current status of the discussion is reached (offline time OF:00:54),
an indicator IND for the offline reproduction of the conversation totals,
the control options SB provided to the user.

In the exemplary embodiment of FIG. 2 the following are shown as control options:
SK=“Total jump”, with which a direct jump can be made to the next conversation total,
RE=“Play total from beginning”, with which a direct jump can be made to the beginning of the current conversation total,
TH=“Increase tempo”, with which the playback tempo can be increased, and

TR=“Reduce tempo”, with which the playback tempo can be reduced.

Not shown, but also possible, are the control options “Cancel playback”, with which a direct jump can be made to the current status of the PTT group discussion, and also “Stop playback” (self-explanatory) and also further useful control commands which provide the late entry user in a convenient manner with information about the content of the earlier conversation totals already stored.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-15. (canceled)

16. A method for late-entry of an existing push-to-talk conversation via at least one radio communication device, comprising:
obtaining and storing current conversation totals for each radio communication device in at least one intermediate exchange unit;
determining missed conversation totals by at least one radio communication device entering an existing push-to-talk discussion; and
transmitting missed conversation totals from the exchange unit to the at least one radio communication device entering an existing push-to-talk discussion, wherein the missed conversation totals are in a format to be reproduced on the device.

17. The method according to claim 16, wherein at least one conversation total stored in the exchange unit is formatted to be played back at higher playback speed when it is reproduced.

18. The method according to claim 16, wherein pauses between conversation totals are shortened or omitted when these totals are reproduced.

19. The method according to claim 16, wherein conversation pauses within a conversation total are shortened or omitted when these totals are reproduced.

20. The method according to claim 16, further comprising:
signalling status information to a relevant late entry radio communication device with the aid of at least one control signal from the exchange unit as to the total offline time which is predicted to elapse for the reproduction of the stored conversation totals until the current status of the push-to-talk group discussion is reached.

21. The method according to claim 16, further comprising:
signalling status information to a relevant late entry radio communication device with the aid of at least one control signal from the exchange unit as to whether the current status of the push-to-talk group discussion has already been reached and active participation in the current push-to-talk group discussion in realtime is enabled.

22. The method according to claim 20, wherein the exchange unit, upon determining the relevant remaining overall offline time predicted to elapse for reproduction of the stored conversation totals, calculates in the playback times for further new conversation totals arriving in the interim, and that the updated overall playback time is signalled by the exchange unit after entry of the relevant new conversation totals to the late entry radio communication device.

23. The method according to claim 16, wherein real-time participation in the current push-to-talk group conversation for sending conversation totals for the late-entry radio communication device is enabled by the exchange unit with the aid of at least one control signal

24. The method according to claim 23, wherein and a status is indicated to the user of the late-entry radio communication device if all or some of the already stored conversation totals have been played back or have been skipped entirely or in part instead of being reproduced.

25. The method according to claim 16, wherein the exchange unit transfers to the late-entry radio communication device, with the aid of at least one control signal, a list of the already stored conversation totals of the radio communication devices already involved in the push-to-talk group conversation.

26. The method according to claim 16, wherein the exchange unit transfers to the user interface of the late entry radio communication device, with the aid of at least one control signal, a selection list for selecting one or more control commands, which are used for influencing the reproduction of one or more stored conversation totals when called up from the exchange unit.

27. The method according to claim 26, wherein the late entry radio communication device transfers one or more selected control commands for influencing the reproduction of one or more stored conversation totals to the exchange unit.

28. The method according to claim 27, wherein the relevant control command selected is executed on the relevant stored conversation total when it is retrieved.

29. The method according to claim 16, wherein a mobile radio device is the radio communication device.

30. The method according to claim 16, wherein a transmission path between the exchange unit and the radio communication device involved in the relevant push-to-talk group discussion includes an air interface.

31. A radio communication device for late-entry of an existing push-to-talk conversation in a network, comprising:
a control unit;
an interface, operatively coupled to the control unit, for receiving current and missed network conversation totals for each radio communication device participating in the push-to-talk conversation; and
a processor, communicatively coupled to the control unit for reproducing missed conversation totals in the device.

32. An exchange unit for processing push-to-talk conversations via a plurality of radio communication devices in a network, comprising:
a memory device for storing current conversation totals for each radio communication device participating in the push-to-talk conversation, wherein the conversation totals are stored in a format to be reproduced on the radio communication devices;
a control unit, operatively coupled to the memory device, for determining conversation totals missed by at least one radio communication device entering an existing push-to-talk discussion; and
a part for transmitting missed conversation totals to the at least one radio communication device entering an existing push-to-talk discussion.
